(19) United States
(12) Patent Application Publication
(10) Pub. No.: US 2020/0039453 A1
(43) Pub. Date: Feb. 6, 2020

(54) VEHICLE CONTROLLER

(71) Applicant: HITACHI AUTOMOTIVE SYSTEMS, LTD., Hitachinaka-shi, Ibaraki (JP)

(72) Inventors: Takahiro IIDA, Tokyo (JP); Hirobumi HANAWA, Hitachinaka-shi, Ibaraki (JP)

(73) Assignee: HITACHI AUTOMOTIVE SYSTEMS, LTD., Hitachinaka-shi, Ibaraki (JP)

(21) Appl. No.: 16/339,261

(22) PCT Filed: Sep. 29, 2017
(86) PCT No.: PCT/JP2017/035428

§ 371 Date: Apr. 3, 2019

(30) Foreign Application Priority Data
Oct. 19, 2016 (JP) 2016-205111

(51) Int. Cl. B60R 16/023; G06F 9/48; G06F 9/50

(52) U.S. Cl. CPC B60R 16/0231; G06F 9/5038; G06F 9/4843

(57) ABSTRACT

A vehicle control apparatus of the present invention includes a plurality of arithmetic devices and changes tasks to be allocated to each arithmetic device, while preventing an increase of an effective load. A vehicle control apparatus according to the present invention includes a task table that defines tasks to be executed by each arithmetic device, and updates the task table when the vehicle control apparatus is activated or terminated.

### TECHNICAL FIELD

The present invention relates to a vehicle control apparatus.

### BACKGROUND ART

Currently, various types of vehicle control apparatuses (electronic control units) equipped with multicore microcomputers are being developed. A current multicore ECU is basically designed to fixedly allocate tasks to be executed by each core in advance. For products with low real-time characteristics, such as personal computers, allocation of tasks is dynamically changed during execution of software (after the ECU is fully activated). However, for products with high real-time characteristic, such as vehicle control apparatuses, it is difficult to dynamically allocate tasks from the viewpoint of execution load.

A vehicle control apparatus in PTL 1 below prepares combination patterns of task processing sequence in advance as task tables and dynamically allocates tasks according to the situation by switching the combination patterns.

### CITATION LIST

### Patent Literature

PTL 1: JP 2013-199180 A

### SUMMARY OF INVENTION

### Technical Problem

In the method described in PTL 1, task allocation can only be selected from previously designed combination patterns. If both the number of tasks and the number of cores are increased in the future, the number of combinations increases exponentially, causing a difficulty for the designer to evaluate all combinations in advance and design appropriate combination patterns. On the other hand, in a product with high real-time characteristic, such as a vehicle control apparatus, it is difficult to dynamically change the task allocation, because the processing load of the task scheduling function is often unacceptable.

The present invention has been made to solve the above problems, and it is an object of the present invention to provide a vehicle control apparatus including a plurality of arithmetic devices, which changes a task to be allocated to each arithmetic device, while preventing an increase of execution load.

### Solution to Problem

A vehicle control apparatus according to the present invention includes a task table that defines tasks to be executed by each arithmetic device, and updates the task table when the vehicle control apparatus is activated or terminated.

### Advantageous Effects of Invention

According to the vehicle control apparatus of the present invention, it is possible to optimize allocation of tasks to be executed by each arithmetic device, while preventing an increase of calculation load.

### BRIEF DESCRIPTION OF DRAWINGS

FIG. 1 is a configuration diagram of a vehicle 1 equipped with a vehicle control apparatus according to a first embodiment.

FIG. 2 illustrates a hardware (H/W) configuration of a vehicle control system 2.

FIG. 3 is a block diagram illustrating an internal configuration of an ECU 22.

FIG. 4 illustrates a module configuration of a control program executed by a processor 221.

FIG. 5 illustrates a configuration example of a task table 2272.

FIG. 6 is another configuration example of the task table 2272.

FIG. 7 is a flowchart illustrating an operation procedure when an ECU 22 is activated.

FIG. 8 is a flowchart illustrating an operation procedure when the ECU 22 is terminated.

FIG. 9 illustrates an example of the task table 2272 of a second embodiment.

FIG. 10 illustrates an example of the task table 2272 of a third embodiment.

FIG. 11 illustrates a module configuration of the ECU 22 according to a fourth embodiment.

FIG. 12 illustrates a module configuration of the ECU 22 according to a fifth embodiment.

### DESCRIPTION OF EMBODIMENTS

### First Embodiment

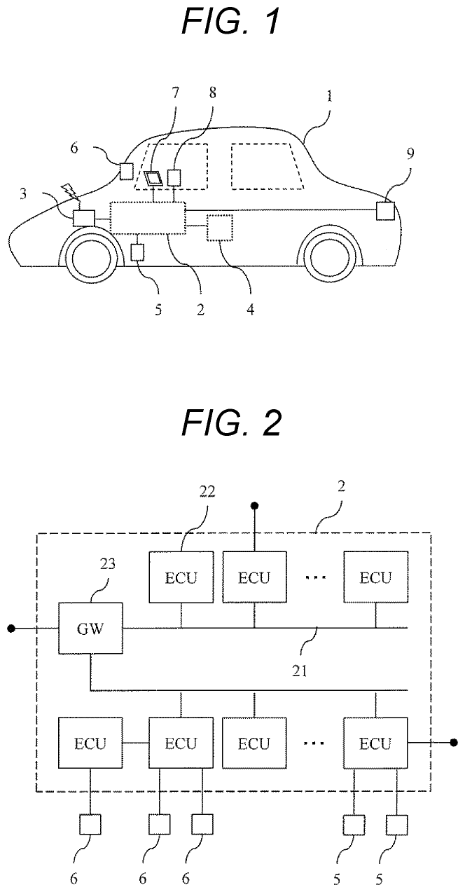

FIG. 1 is a configuration diagram of a vehicle 1 equipped with a vehicle control apparatus according to a first embodiment of the present invention. The vehicle 1 is a vehicle electronically controlled by a vehicle control apparatus and includes a vehicle control system 2, a communication device 3, a vehicle control system 4, a drive device 5, a recognition device 6, an output device 7, an input device 8, and a notification device 9.

The vehicle control system 2 is a system that controls individual elements of the vehicle 1, and is constituted by, for example, an on-board network (e.g., a controller area network (CAN), a CAN with flexible data-rate (CANFD), or Ethernet (registered trademark)), and a controller such as an electronic control unit (ECU). The vehicle control system 4 is a system configured on an on-board network different from the vehicle control system 2.

The communication device 3 performs wireless communication (e.g., communication using cellular phones, communication using wireless LAN or WAN, or the like) with the outside of the vehicle control system 2, and acquires and transmits information on the outside world (infrastructure or other vehicles) or the own vehicle. The communication device 3 further includes a diagnostic terminal (OBD), an Ethernet terminal, an external recording medium (e.g., a USB memory, an SD card, or the like) terminal, and communicates with the vehicle control system 2 via wired connection.

The drive device 5 is a device such as an actuator that drives machines and electric devices (e.g., an engine, transmission, wheels, brakes, a steering device, and the like) for controlling movement of the vehicle under the control of the vehicle control system 2.

The recognition device 6 is constituted by (a) an external sensor, such as a camera, a radar, an LIDAR, an ultrasonic sensor, or the like, which acquires information input from the outside world to generate external recognition information, and (b) a mechanical sensor (e.g., acceleration, wheel speed, a global positioning system (GPS), or the like) that recognizes the state (e.g., kinetic state, positional information, or the like) of the vehicle 1.

The output device 7 is a device such as a liquid crystal display, an alert lamp, a speaker, or the like, which is connected wired or wirelessly to the vehicle control system 2 to receive data transmitted from the vehicle control system 2, and displays or outputs necessary information such as message information (e.g., video or sound). The input device 8 is a device such as a steering wheel, pedals, buttons, levers, or a touch panel which generates an input signal that is entered by a user as an operational intention or instruction to the vehicle control system 2. The notification device 9 is a device, such as lamps, LEDs, speakers, or the like, with which the vehicle 1 notifies the outside world of the state or the like of the vehicle 1.

FIG. 2 illustrates a hardware (H/W) configuration of the vehicle control system 2. A network link 21 is a communication network connecting with individual control devices, and is constituted by, for example, a CAN bus or the like. An ECU 22 is connected to the network link 21, the drive device 5, the recognition device 6, and the like. The ECU 22 controls the drive device 5 and the recognition device 6, and transmits and receives data via the network link 21. A gateway (GW) 23 relays data in the network links 21.

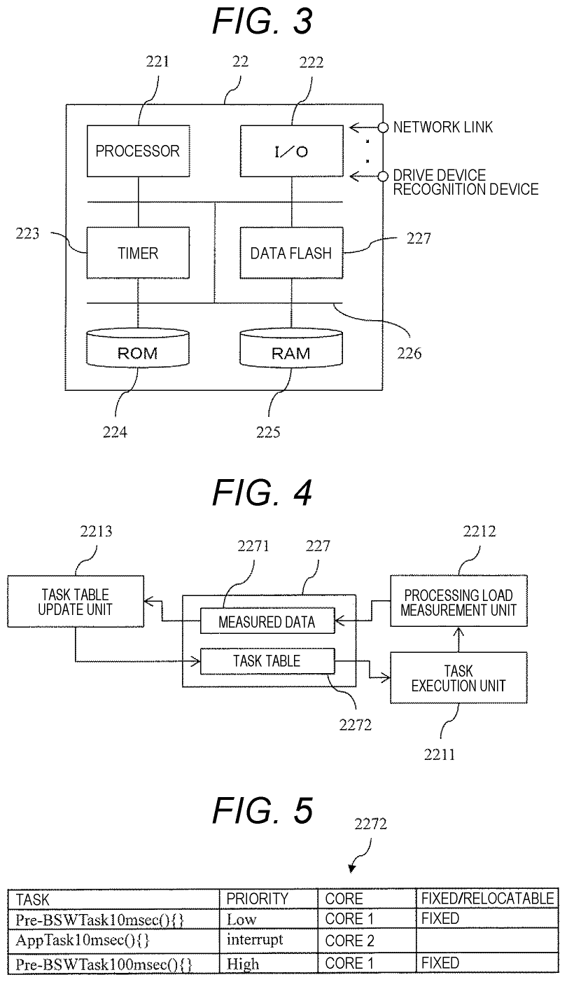

FIG. 3 is a block diagram illustrating an internal configuration of the ECU 22. A processor 221 includes a storage element such as a cache or a register, and executes a control program to control each functional unit of the vehicle 1. The processor 221 includes at least one processor core. An I/O 222 transmits and receives data to and from the network link 21, the drive device 5, the recognition device 6, and the like. A timer 223 manages time using a clock (not illustrated) or the like. A read only memory (ROM) 224 stores nonvolatile data such as a control program. A random access memory (RAM) 225 stores volatile data. An internal bus 226 is used for communication within the ECU 22. A data flash 227 is a storage device that stores data used when the processor 221 executes the control program.

FIG. 4 illustrates a module configuration of the control program executed by the processor 221. The control program includes a task execution unit 2211, a processing load measurement unit 2212, and a task table update unit 2213.

The task execution unit 2211 executes a task. The task, as used herein, is referred to as processing in which the control arithmetic operation executed by the control program is divided into certain units. The task execution unit 2211 repeats each task, for example, periodically, or executes the task upon events such as sensor input or user operation. Priority is assigned to each task, and when a plurality of tasks are executable simultaneously in the same processor core, the processor core executes the task with the highest priority.

The processing load measurement unit 2212 measures a processing load when the task execution unit 2211 executes the task and stores the result in the data flash 227 as measured data 2271. The processing load, as used herein, is referred to as, for example, task execution time per unit time. If the execution time of the task in 1 second is 500 mm, the processing load is 50%. The processing load measurement unit 2212 measures the processing load every time the task execution unit 2211 executes a task once.

The task table update unit 2213 acquires the measured data 2271 and updates the task table 2272 so that the processing load is leveled among the processor cores. The task table 2272 is a data table that defines a task to be executed by each processor core. A specific example of the task table 2272 will be described later. The task table update unit 2213 updates the task table 2272 when the ECU 22 is activated or terminated. Details on activation and termination will be described later.

When a difference between the processing loads of the processor cores exceeds a threshold value, the task table update unit 2213 can judge that the task table 2272 needs to be updated. In this case, the task table 2272 may be updated so that the difference between the processing loads of the processor cores does not exceed a threshold (or is desirably minimized). If it does not exceed the threshold value, there is no need to update the task table 2272.

FIG. 5 illustrates a configuration example of the task table 2272. The task table 2272 includes a data field that designates a processor core in which the task is to be executed. In FIG. 5, it is defined that the processor core “core 1” executes the task “Pre-BSWTask10msec ( )”. Further, the task table 2272 may also define the priority of each task and whether it is possible to change the processor core executing each task (whether task allocation is fixed or relocatable). The task table update unit 2213 does not update a portion of the task table 2272 corresponding to the task for which the processor core that executes the task is fixed.

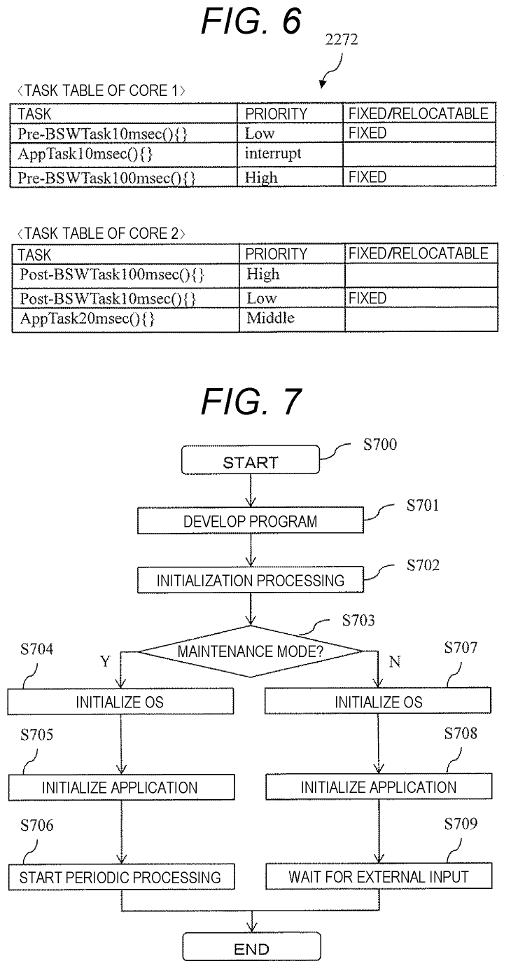

FIG. 6 illustrates another configuration example of the task table 2272. The ECU 22 may also have a task table 2272 for each processor core. In this case, each task table 2272 defines a task to be executed by each processor core. In the example illustrated in FIG. 6, the first task table 2272 defines only tasks to be executed by the core 1, and the second task table 2272 defines only tasks to be executed by the core 2.

Regardless of whether the task table 2272 has the configuration of FIG. 5 or FIG. 6, the task table update unit 2213 updates the task table 2272 by recording the task to be executed by each processor core in the task table 2272.

FIG. 7 is a flowchart for explaining the operation procedure when the ECU 22 is activated. This flowchart starts when the vehicle 1 is activated by, for example, turning on an ignition switch of the vehicle 1 (S700). Steps in FIG. 7 will be described below.

### (FIG. 7: Steps S701 to S702)

The processor 221 reads the control program from the ROM 224 and develops the control program on the RAM 225 (S701). The processor 221 executes the control program to execute initialization processing (S702). The initialization processing can be implemented as part of the control program.

### (FIG. 7: Step S703)

The processor 221 determines whether the ECU 22 is activated in a normal mode or a maintenance mode. If activated in the maintenance mode, steps S704 to S706 are executed. If activated in the normal mode, steps S707 to S709 are executed. Which activation mode the ECU 22 has been started in is determined in accordance with the fact that, for example, a signal that gives an instruction of activation in the maintenance mode is input from the communication device 3.

### (FIG. 7: Steps S704 to S706)

The processor 221 initializes the operating system (OS) of the ECU 22 (S704). The processor 221 initializes the application defined by the control program (S705). The processor 221 starts periodic processing defined by the control program (S706).

### (FIG. 7: Steps S707 to S709)

The processor 221 initializes the operating system (OS) of the ECU 22 (S707). The processor 221 initializes the application defined by the control program (S708). The processor 221 waits until an external input such as a maintenance command is input via the communication device 3 (S709).

The task table update unit 2213 updates the task table 2272 at any point of time between the start of step S701 and the end of step S704 (or S707) (i.e., during activation processing in which the ECU 22 is activated). As a result, task allocation is performed before the control processing of the ECU 22 starts, allowing the tasks to be relocated without affecting the real-time characteristic of the control processing.

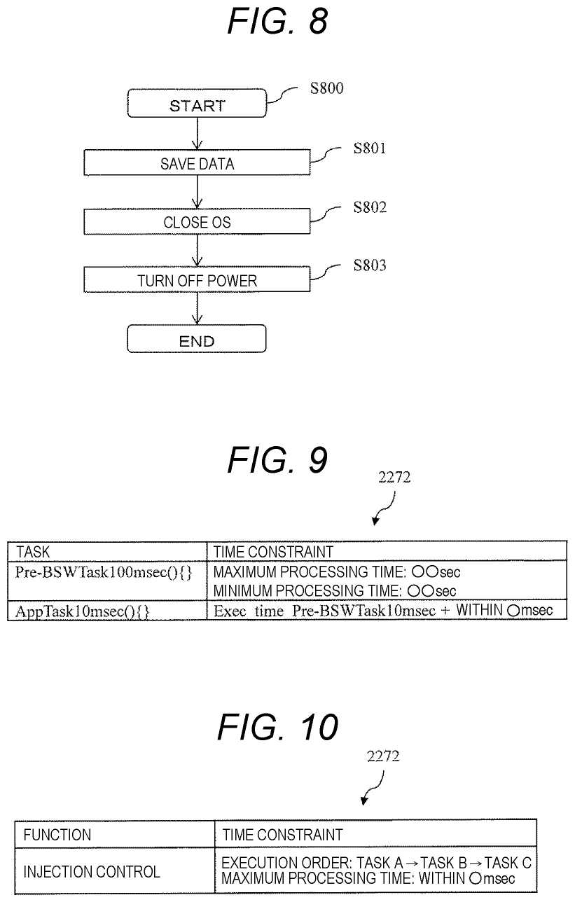

FIG. 8 is a flowchart for explaining the operation procedure when the ECU 22 is terminated. This flowchart starts when the condition to terminate the ECU 22 is satisfied (e.g., the ignition switch of the vehicle 1 being turned off) (S800). The processor 221 executes termination processing, such as returning the actuator to the start position and ending the control program, while saving the data to be read at the next activation to the data flash 227 (S801). The processor 221 terminates the OS (S802) and turns off the power supply of the ECU 22 (S803).

The task table update unit 2213 updates the task table 2272 at any point of time between the start of step S801 and the end of step S803 (i.e., during the termination processing in which the ECU 22 is terminated). As a result, task allocation is performed at the point in time after the control processing of the ECU 22 is completed, so that the tasks can be relocated without affecting the real-time characteristic of the control processing. The task table update unit 2213 may update the task table 2272 only when the ECU 22 is activated or terminated, or when the ECU 22 is both activated and terminated.

In a case where the task table 2272 also defines the fixed or relocatable task allocation, the possibility of malfunctioning due to the change of the task allocation can decrease by updating the task allocation according to the definition. Furthermore, when priority is also defined, the task allocation can be updated by considering the priority.

### Second Embodiment

FIG. 9 is an example of the task table 2272 according to a second embodiment of the present invention. As in FIG. 6, the example illustrates the case where the task table 2272 is provided for each processor core. Since the configuration of the ECU 22 is similar to that of the first embodiment, a difference regarding the task table 2272 is mainly described below.

The task table 2272 in the second embodiment defines execution time constraint as a task attribute. The task table update unit 2213 allocates a task to each processor core so that the execution time constraint can be satisfied. Examples of the execution time constraint include the following ones.

The maximum processing time constraint (the first row in FIG. 9) is the maximum time that can be tolerated as the time taken from the start to end of the execution of the task by the task execution unit 2211. The maximum processing time constraint can be used to prevent the increase of the processing time longer than the design intention as a result of repeating other tasks having high priorities.

The minimum processing time constraint (the first row in FIG. 9) is the minimum time that can be tolerated as the time taken from the start to end of the execution of the task by the task execution unit 2211. For example, if the task is ended in a shorter time than originally intended time due to the ending of the task halfway, the minimum processing time constraint may not be satisfied.

The activation start time constraint (second line in FIG. 9) is the maximum time that can be tolerated as an interval between the end of the previous task and the start of the next task when a plurality of tasks are executed consecutively. For example, when the task switching function is activated by interrupt processing, the next task may not immediately start after the previous task is ended, thus not satisfying the activation start time constraint.

The task table update unit 2213 can update the task table 2272 by, for example, the following procedure. The task table update unit 2213 obtains a task allocation by which the processing loads are leveled most among the processor cores, and determines whether the execution time constraint of each task is satisfied with the obtained task allocation. At this time, the processing load relating to the communication between the processor cores may be held in advance and taken into consideration in determining whether the constraint is satisfied. If the execution time constraint is not satisfied, similar determination is repeated for sub-optimal task allocation. Then, the task allocation satisfying all execution time constraints is, when obtained, written to the task table 2272.

Since the ECU 22 according to the second embodiment changes the task allocation so as to satisfy the execution time constraint defined by the task table 2272, it is possible to prevent the control from becoming unstable due to unobserved execution time constraint. In particular, the control devices, such as the engine or the brake, that need to have real-time characteristic can level the processing loads among the processor cores, while satisfying the time constraint.

### Third Embodiment

FIG. 10 illustrates an example of the task table 2272 according to a third embodiment of the present invention. As in FIG. 6, the example illustrates the case where the task table 2272 is provided for each processor core. Since the configuration of the ECU 22 is similar to that of the first embodiment, a difference regarding the task table 2272 is mainly described below.

There is a case where one control function is implemented by executing a plurality of tasks in a predetermined order. Such tasks do not work as a control function if the execution order changes, so that it is necessary to maintain the execution order when changing the task allocation. Therefore, in the third embodiment, the execution order is defined as the constraint condition in the task table 2272 when the task execution order is fixed in advance.

In the example illustrated in FIG. 10, the function of controlling fuel injection is defined in the execution order of task A=>task B=>task C. To maintain the execution order of these tasks, it is desirable to allocate these tasks collectively to the same processor core. In addition, the maximum processing time constraint between the start of task A and the end of task C is also defined. According to the procedure described in the second embodiment, the task table update unit 2213 can obtain the task allocation by which the processing loads are leveled most among the task allocations satisfying the constraint conditions.

Since the ECU 22 according to the third embodiment changes the task allocation while maintaining the task execution order defined in advance for each control function, it is possible to level the processing loads without searching all the combinations of the task allocations, while keeping the execution order constraint.

### Fourth Embodiment

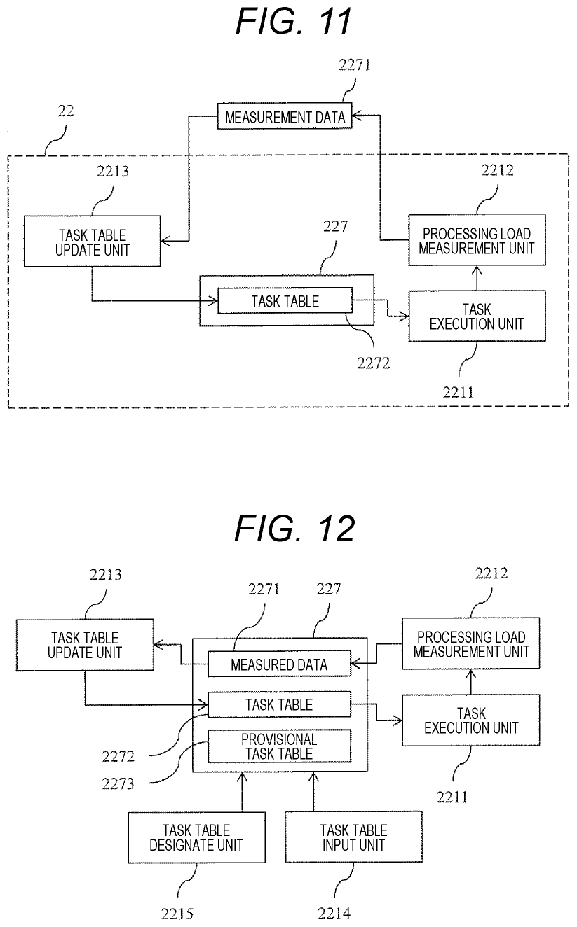

FIG. 11 illustrates a module configuration of the ECU 22 according to a fourth embodiment of the present invention. In the fourth embodiment, the processing load measurement unit 2212 stores the measured data 2271 in an external storage device installed outside the ECU 22. Since the other portions of the configuration are the same as those of the first embodiment, a difference regarding the external storage device is described below.

The external storage device may be disposed inside the vehicle control system 2, or may be disposed outside the vehicle 1. In any case, it is desirable that a plurality of ECUs 22 can access the external storage device. Using the result of measuring the processing load of each of the plurality of ECUs 22, the task allocation can be optimized.

### Fifth Embodiment

FIG. 12 illustrates a module configuration of the ECU 22 according to a fifth embodiment of the present invention. The ECU 22 of the fifth embodiment includes, in addition to the configuration described in the first embodiment, a task table input unit 2214 and a task table designate unit 2215. Since the other portions of the configuration are the same as those of the first embodiment, a difference is mainly described below.

The task table input unit 2214 receives, for example, a task table described by the user and stores the task table in the data flash 227 as a provisional task table 2273. For example, the user can input the task table via the communication device 3 or by network transmission via the on-vehicle network provided in the vehicle control system 2. Other suitable means may also be used. The user can input and save a plurality of provisional task tables 2273.

The task table designate unit 2215 receives data designating which of the provisional task tables 2273 is adopted as the task table 2272, and reflects the result as the task table 2272. For example, the user can input an instruction to the task table designate unit 2215 via the communication device 3 or by network transmission via the on-vehicle network of the vehicle control system 2.

The ECU 22 according to the fifth embodiment can use the task allocation which is desired by the user, and can flexibly adapt to various needs of the user. Updating the task table 2272 by the task table update unit 2213 may also be performed. For example, the task table 2272 created by the task table update unit 2213 can be used when no task table is input or designated by the user. Alternatively, the user may designate the task table 2272 itself created by the task table update unit 2213.

### <Modification of Present Invention>

The present invention is not limited to the embodiments described above, and may also include various modifications. For example, the embodiments described above have been given in detail to facilitate the understanding of the present invention, and are not necessarily limited to those including all constituent components described above. Further, a portion of the structure of a certain embodiment can be partially replaced by a portion of other embodiments, or the portions of other embodiments can be added to the structure of a certain embodiment. Further, some of the constituent components of each embodiment may be added, deleted, or substituted for by other constituent components.

The above embodiments have described leveling of the processing loads among the processor cores, but the present invention can also be applied to the leveling of the processing loads among other arithmetic devices. For example, the leveling may be performed among processors or the ECUs.

In the above embodiments, the bus type network is illustrated and described in FIG. 2 as an example, and other topologies may be used. Other examples include (a) a star-type topology in which a plurality of ECUs 22 are directly connected to GW 23, (b) a link-type topology in which the ECUs 22 are connected in a ring shape, and (c) a mixed topology constituted by a plurality of networks of the above types in a mixed manner. For the GW 23 and the ECUs 22, the ECUs 22 each having a function as a GW may be used, or the GW 23 having a function of the ECU 22 may be used.

In the above embodiment, measurement of the task execution time as the processing load has been described. More specifically, for example, the worst execution time may be measured as the processing load. The tasks, therefore, can be re-allocated, while guaranteeing that each task is ended within the scheduled execution period.

### REFERENCE SIGNS LIST

1 vehicle
2 vehicle control system
21 network link
22 ECU
221 processor
2211 task execution unit
2212 processing load measurement unit
2213 task table update unit
2214 task table input unit
2215 task table designate unit
222 I/O
223 timer
224 ROM
225 RAM
226 internal bus
227 data flash
2271 measured data
2272 task table
2273 provisional task table
23 GW
3 communication device

1. A vehicle control apparatus that controls operation of a vehicle, comprising:
a storage unit that stores a task table defining an arithmetic device which is configured to execute a control task for controlling the operation of the vehicle;
first and second arithmetic devices that execute the control task according to the definition of the task table; and
an update unit that updates the task table when the vehicle control apparatus is activated or terminated.

2. The vehicle control apparatus according to claim 1, further comprising:
a processing load measurement unit that measures a worst processing load taken for the first and second arithmetic devices to execute the control task, wherein
the update unit updates the task table in a manner that a total processing load of the first and second arithmetic devices is leveled in accordance with the worst processing load measured by the processing load measurement unit.

3. The vehicle control apparatus according to claim 1, wherein
the task table defines which of the first and second arithmetic devices needs to execute the control task, and
the first and second arithmetic devices identify the control task to be executed by referring to the task table and execute the identified control task.

4. The vehicle control apparatus according to claim 1, wherein
the task table includes a first sub-table that defines the control task to be executed by the first arithmetic device and a second sub-table that defines the control task to be executed by the second arithmetic device,
the update unit records only the control task to be executed by the first arithmetic device in the first sub-table, and records only the control task to be executed by the second arithmetic device in the second sub-table,
the first arithmetic device executes the control task defined by the first sub-table, and
the second arithmetic device executes the control task defined by the second sub-table.

5. The vehicle control apparatus according to claim 1, wherein
the task table defines a fixed task for which one of the first and second arithmetic devices needs to execute the control task is fixed and a relocatable task for which one of the first and second arithmetic devices needs to execute the control task is not fixed, and
the update unit updates only a portion of the task table defining the relocatable task.

6. The vehicle control apparatus according to claim 1, wherein
the task table defines allowable execution time designating a range of time allowable as time taken for executing the control task, and
the update unit updates the task table in a manner that the first and second arithmetic devices satisfy the allowable execution time when the first and second arithmetic devices execute the control task according to the updated task table.

7. The vehicle control apparatus according to claim 1, wherein
the task table defines an execution order of the control tasks, and
the update unit updates the task table in a manner that the execution order is satisfied when the first and second arithmetic devices execute the control task according to the updated task table.

8. The vehicle control apparatus according to claim 2, wherein
the processing load measurement unit writes measured data describing a measurement result of the worst processing load in an external storage device disposed outside the vehicle control apparatus, and
the update unit acquires the measured data from the external storage device and updates the task table in accordance with the acquired measured data.

9. The vehicle control apparatus according to claim 1, further comprising:
a task table input unit that receives data designating the definition of the task table, wherein
the update unit updates the task table according to the data received by the task table input unit.

10. The vehicle control apparatus according to claim 1, wherein
the storage unit stores a plurality of the task tables,
the vehicle control apparatus further includes a task table designate unit that receives data designating which of the definitions of the task tables needs to be adopted, and
the first and second arithmetic devices execute the control task according to the definition of the task table designated by the data received by the task table designate unit.
